(19) United States
(12) Patent Application Publication
(10) Pub. No.: US 2018/0341825 A1
(43) Pub. Date: Nov. 29, 2018

(54) AUTOMATIC SAMPLING DEVICE

(71) Applicant: SHIMADZU CORPORATION, Kyoto-shi (JP)

(72) Inventor: Hiroyuki MINATO, Kyoto-shi (JP)

(73) Assignee: SHIMADZU CORPORATION, Kyoto-shi (JP)

(21) Appl. No.: 15/606,057

(22) Filed: May 26, 2017

(51) Int. Cl. G06K 9/32; G01N 30/24; G01B 11/14

(52) U.S. Cl. CPC G06K 9/32; G01N 2030/027; G01B 11/14; G01N 30/24

(57) ABSTRACT

In an automatic sampling device for automatically collecting a sample from a sample-holding container having a top surface on which a plurality of sample-holding portions as well as one or more reference points for position adjustment whose relative position to the sample-holding portions is previously known are provided, the automatic sampling device includes: a housing having an opening on a front side for allowing the sample-holding container to be set inside, the housing configured so that a closed space is formed inside when the opening is closed; a sample collector for collecting a sample from any one of the sample-holding portions of the sample-holding container set within the housing; and an appearance information acquisition assistant which assists in an acquisition of appearance information including the sample collector and the one or more reference points for position adjustment of the sample-holding container set within the housing.

### TECHNICAL FIELD

The present invention relates to an automatic sampling device for automatically collecting a sample from a plurality of sample-holding portions in which samples are held, and introducing the sample into an analyzer. In particular, it relates to an auto-sampler for collecting a liquid sample and introducing it into a liquid chromatograph.

### BACKGROUND ART

In the process of automatically analyzing a plurality of samples using an analyzer, such as a liquid chromatograph, an automatic sampling device (“auto-sampler”) for sequentially collecting a liquid sample from each of a plurality of sample-holding portions and introducing the sample into the analyzer is used. For example, in the auto-sampler, a plurality of vials containing liquid samples are set in a plurality of sample-holding portions provided on the top surface of a sample rack. Then, using a sampling needle, the auto-sampler sequentially collects a predetermined amount of liquid sample from the vial in each of the sample-holding portions in a predetermined order and injects the sample into the analyzer.

In an auto-sampler, a teaching task for the sampling needle is performed so that liquid samples can be properly collected from the vials on the sample rack. A “teaching” task is the task of registering the position coordinates of the sample-holding portions of the sample rack relative to the reference position of the sampling needle (relative position between the sampling needle and the sample-holding portions). Since even the same model of auto-samplers have individual differences, the teaching task should be performed for each individual device. Additionally, the size and number of the sample-holding portions vary depending on the kind of sample rack. A difference in the size and/or number of the sample-holding portions means a difference in the positional relationship between the sampling needle and the sample-holding portions. Accordingly, the teaching task should be performed for all kinds of sample racks that can be used in the auto-sampler concerned. Such a teaching task is manually performed by an operator in each case.

Patent Literature 1 discloses a technique in which a hole serving as the reference position is provided on the top surface of the sample rack, and the teaching task is performed by inserting the sampling needle into that hole. In such a teaching task, three holes serving as the reference are normally provided on the top surface of the sample rack. The sample rack is set in the auto-sampler in such a manner that two holes are located on the front side of the auto-sampler and one hole on the rear side.

### CITATION LIST

### Patent Literature

Patent Literature 1: JP 2000-146775 A

### SUMMARY OF INVENTION

### Technical Problem

In the previously described teaching task, when inserting the sampling needle into the two holes on the front side of the auto-sampler, the operator can perform the task while visually checking the relative position between the sampling needle and the holes.

However, the relative position of the sampling needle to the rear hole is not easy to check, and it is difficult to accurately insert the sampling needle into that hole. Therefore, the operator needs to perform the task of inserting the sampling needle into this hole by trial and error. Such a process deteriorates the efficiency of the teaching task.

Although the present description is concerned with a sample rack which carries vials containing liquid samples, a similar problem also occurs in the case of a microplate having a plurality of holes for holding liquid samples.

Thus, in an automatic sampling device in which a sample-holding container with a plurality of sample-holding portions formed on its top surface is set and the samples held in a part or all of the sample-holding portions are collected using a sample collector, the present invention addresses the problem of improving the efficiency of the teaching task for setting the relative position between the sample collector and the plurality of sample-holding portions.

### Solution to Problem

The present invention developed for solving the previously described problem is an automatic sampling device for automatically collecting a sample from a sample-holding container having a top surface on which a plurality of sample-holding portions as well as one or more reference points for position adjustment whose relative position to the sample-holding portions is previously known are provided, the automatic sampling device including:

a) a housing having an opening on a front side for allowing the sample-holding container to be set inside, the housing configured so that a closed space is formed inside when the opening is closed;

b) a sample collector for collecting a sample from any one of the sample-holding portions of the sample-holding container set within the housing; and

c) an appearance information acquisition assistant which assists in an acquisition of information of appearance including the sample collector and the one or more reference points for position adjustment of the sample-holding container set within the housing.

For example, the sample-holding container is a sample rack or microplate. In the case of the sample rack, vial-holding portions on which vials containing liquid samples are to be placed become the sample-holding portions. In the case of the microplate, liquid-sample-holding portions shaped like a well become the sample-holding portions.

The one or more reference points for position adjustment may be provided separately from the sample-holding portions. Alternatively, some of the sample-holding portions may be used as the reference points for position adjustment.

The automatic sampling device according to the present invention is suitable as a device for collecting liquid samples, but is not limited to liquid samples; it may also be a device for collecting powdery samples or other forms of samples.

The appearance information acquisition assistant helps an operator grasp the relative positional relationship between the sample collector and the reference points for position adjustment provided on a sample-holding container set within the housing. As will be described later, the assistant may be a device which itself acquires the information of the appearance (appearance information), or a device which assists an operator in acquiring the appearance information. The appearance information acquisition assistant may preferably be configured to assist in the acquisition of the appearance information of the sample collector and the reference points for position adjustment as viewed from an upper or lateral space within the housing. This allows the operator to directly check, from the front side, the aforementioned relative positional relationship between the sample collector and the reference points for position adjustment in a two-dimensional form (as two-dimensional information) as well as the relative position in the front-rear direction from the appearance information obtained through the appearance information acquisition assistant, to eventually grasp, in a three-dimensional form, the relative positional relationship between the sample collector and the reference points for position adjustment.

For example, the appearance information acquisition assistant may be a reflector provided on a portion of an inner wall surface (e.g. side surface) of the housing. In this case, the operator can directly check the relative position between the sample collector and the reference points for position adjustment from the front side of the housing to obtain two-dimensional information as viewed from the front side, and additionally check the relative position between the sample collector and the reference points for position adjustment mirrored by the reflector to obtain two-dimensional information as viewed from a lateral side.

The appearance information acquisition assistant may include: an imager (camera) for capturing the sample collector and a portion or the entirety of the reference points for position adjustment within a visual field; and a display section for displaying an image taken with the imager. The camera may be fixed within the housing, or it may be attached to the sample collector so that it moves with the sample collector.

The appearance information acquisition assistant may be an illuminator for illuminating the sample collector. In this case, the operator can check the relative position between the sample collector and the reference points for position adjustment from the front side of the housing, and additionally check the relative position between the shadow of the sample collector and the reference points for position adjustment, to eventually obtain three-dimensional information.

In the automatic sampling device according to the present invention, the operator visually recognizes, from the front side of the housing, the position of the sample collector and one or more reference points for position adjustment provided on the top surface of the sample-holding container set within the housing, to check their relative positional relationship in a two-dimensional form (as two-dimensional information). In addition to this two-dimensional information as viewed from the front side of the housing, the operator also obtains another piece of two-dimensional information on the position of the sample collector and the reference points for position adjustment as viewed in a different direction with the help of the appearance information acquisition assistant. In conventional automatic sampling devices, the relative positional relationship between the sample collector and the reference point for position adjustment located in the rear area of the housing is difficult to recognize, since the operator needs to visually check their positional relationship from the front side of the housing. In the automatic sampling device according to the present invention, the appearance information acquisition assistant facilitates the task of recognizing the relative positional relationship between the sample collector and the reference point for position adjustment located in the rear area of the housing. Consequently, the efficiency of the teaching task is improved.

The appearance information acquisition assistant may include:

an imager for capturing the sample collector and a portion or the entirety of the one or more reference points for position adjustment within a visual field;

a reflector located within the visual field of the imager and positioned in such a manner that a portion or the entirety of the one or more reference points for position adjustment are captured within the visual field of the imager through the reflector; and

a display section for displaying an image taken with the imager.

In the previously described mode of the appearance information acquisition assistant which includes the imager, reflector and display section, the imager directly captures, within its visual field, the sample collector and the reference points for position adjustment provided on the sample-holding container set within the housing, whereby an image (two-dimensional information) showing their relative positional relationship is obtained. Additionally, the imager captures, via the reflector, the sample collector and the reference points for position adjustment within its visual field, whereby another image (two-dimensional information) is obtained in which the sample collector and the reference points for position adjustment are captured from a direction which is different from the direction of the two-dimensional information obtained by directly capturing the sample collector and the reference points for position adjustment within the visual field. Those two images (two-dimensional information) are displayed as a single image on the display section. Accordingly, by simply checking the display section by sight, the operator can grasp the relative positional relationship between the sample collector and the reference points for position adjustment. Consequently, the efficiency of the teaching task is further improved.

### Advantageous Effects of the Invention

By using the automatic sampling device according to the present invention, the efficiency of the teaching task for setting the relative position between the plurality of sample-holding portions provided on the top surface of the sample-holding container and the sample collector for collecting liquid samples held in a portion or the entirety of the plurality of sample-holding portions can be improved.

### BRIEF DESCRIPTION OF DRAWINGS

FIGS. 1A and 1B are configuration diagrams showing the main components of an auto-sampler in the first embodiment.

FIG. 2 is an example of the sample rack used in the first through fourth embodiments.

FIG. 3 is a diagram illustrating the configuration of the appearance information acquisition assistant in the second embodiment.

FIG. 4 is a diagram illustrating the configuration of the appearance information acquisition assistant in the third embodiment.

FIG. 5 is a diagram illustrating the configuration of the appearance information acquisition assistant in the fourth embodiment.

FIG. 6 is a configuration diagram showing the main components of a data processing unit used in the second through fourth embodiments.

### DESCRIPTION OF EMBODIMENTS

Examples which relate to auto-samplers as embodiments of the automatic sampling device according to the present invention are hereinafter described. The auto-sampler in any of those embodiments is used for introducing a liquid sample into a liquid chromatograph.

### First Embodiment

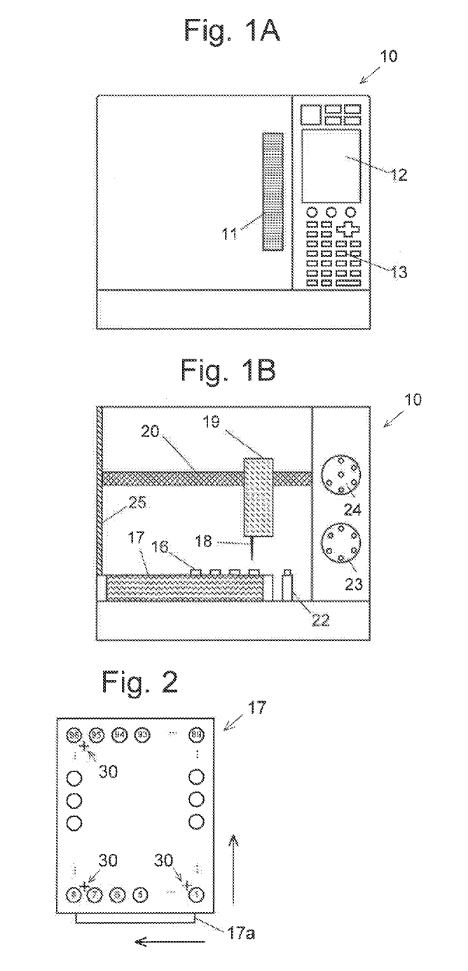

FIGS. 1A and 1B show the configuration of the main components of an auto-sampler 10 as the first embodiment. FIG. 1A is an appearance diagram as viewed from the front side, while FIG. 1B is a diagram schematically showing the inner configuration of the device as viewed from the front side. As shown in FIG. 1A, the auto-sampler 10 has a front handle 11 for opening or closing the door as well as a display section 12 and input section 13. It also contains passage valves 23 and 24 for switching a passage in the liquid chromatograph, as well as a power source and other components. The inner left wall surface of the housing of the auto-sampler 10 is a mirror-like reflecting surface 25. In the first embodiment, this reflecting surface 25 is used as the appearance information acquisition assistant. The display section 12 and input section 13 may be provided on a keypad (not shown) connected to the auto-sampler 10.

As shown in FIG. 1B, a sample rack 17, with vials 16 containing samples placed at predetermined positions, is set in the auto-sampler 10. An injection port 22, washing port (not shown) and drain (not shown) are placed on one side of the set sample rack 17. A sampling needle transfer mechanism 19 including a guide rail 20 for changing the horizontal and vertical positions of a sampling needle 18 is provided over those components. The sampling needle transfer mechanism 19 includes a plurality of built-in motors. By operating those motors, the sampling needle transfer mechanism 19 can be horizontally driven and the sampling needle 18 can be vertically moved. Subsequently, the sample in any one of the vials 16 is collected from the tip of the sampling needle 18 and then injected into the injection port 22.

FIG. 2 is a top view of one example of the sample rack 17 used in the embodiments. This sample rack 17 has 96 vial placement portions (sample-holding portions). The vial placement portions are sequentially numbered, starting from the front side where the handle 17a is provided. Three reference points 30 for position adjustment to be used in the teaching task (which will be described later) are provided on the top surface of the sample rack 17, with two of those points located on the front side and one on the rear side. The sample rack 17 shown in FIG. 2 is one example; it is possible to use a sample rack having a different number of vial placement portions or a sample rack having a microplate placement portion.

The teaching task in the auto-sampler 10 of the first embodiment is described. As already noted, the teaching task is a task for setting the positional relationship between the sampling needle 18 and each vial placement portion on the sample rack 17 before the use of the auto-sampler 10. In the first embodiment, the position of each vial placement portion of the sample rack 17 is determined by setting the positional relationship between the sampling needle 18 and each of the three reference points 30 for position adjustment provided on the top surface of the sample rack 17.

The operator opens the front door of the auto-sampler by the handle 11. With this door open, the operator performs necessary operations on the input section 13 to transfer the sampling needle 18 from a predetermined initial position to one of the reference points 30 for position adjustment, while visually checking the positional relationship between the tip portion of the sampling needle 18 and the one reference point 30 for position adjustment. Then, the operator enters a command through the input section 13 to fix the position of the sampling needle 18, whereupon the coordinates of the selected reference point 30 for position adjustment are set, with the initial position as the origin. After the coordinates of all reference points 30 for position adjustment have been set, the position of each vial placement portion is determined based on those coordinates.

This teaching task is performed for all of the three reference points 30 for position adjustment. For the two reference points 30 for position adjustment located on the front side of the sample rack 17, the operator can directly view the reference point 30 for position adjustment in question and the sampling needle 18 to check their positional relationship. For the reference point 30 for position adjustment located on the rear side of the sample rack 17, the operator checks the positional relationship of the reference point 30 for position adjustment and the sampling needle 18 via the reflecting surface 25 provided on the left side of the auto-sampler 10. This facilitates the position adjustment in the front-rear direction of the auto-sampler 10, which has conventionally been a difficult task.

In the first embodiment, the inner left wall surface of the auto-sampler 10 is entirely mirror-finished into the reflecting surface 25. Alternatively, the wall surface may be partially finished into the reflecting surface 25. The reflecting surface 25 may take various forms as long as its size and location satisfy the condition that the operator can visually recognize the reference point 30 for position adjustment and the sampling needle 18 via the reflecting surface 25. For example, it is possible to provide the reflecting surface on the ceiling inside the auto-sampler 10, or attach the reflecting surface in the vicinity of the area where the sample rack 17 is held within the auto-sampler 10, or attach the reflecting surface to the sampling needle transfer mechanism 19 so that the reflecting surface moves with the sampling needle 18.

### Second Embodiment

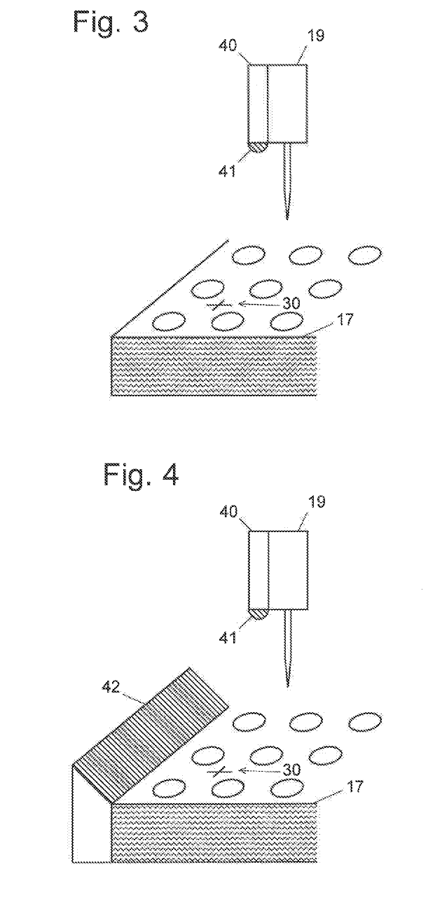

The auto-sampler of the second embodiment is described with reference to FIG. 3. Many components in the auto-sampler 10 are similar to those described in the first embodiment. Accordingly, only the differences from the first embodiment will be described.

In the second embodiment, a camera 40 and the display section 12 are used as the appearance information acquisition assistant. The camera 40 is equipped with a wide angle lens 41 and attached to the sampling needle transfer mechanism 19. A camera equipped with a lens system capable of the 360-degree imaging, such as “SP 360” (product name, manufactured by Kodak Japan, Ltd.) or “GoPano micro” (product name, marketed by GLOBAL SYSTEM K.K.), is suitable as the camera 40. The image taken with the camera 40 is displayed on the display section 12.

In the second embodiment, the operator performing the teaching task can directly view the reference points 30 for position adjustment and the sampling needle 18 to check their positional relationship, and additionally view the image displayed on the display section 12 to check the positional relationship in the front-rear direction of the auto-sampler 10.

In the second embodiment, the shape of the reference point 30 for position adjustment may be captured from the image taken with the camera 40, and the display position of the image may be adjusted so that the reference point 30 for position adjustment comes to a predetermined position (e.g. center) on the screen. In this operation, an image which will be captured by the camera 40 when the position of the tip of the sampling needle 18 coincides with that of the reference point 30 for position adjustment may be superposed on the screen of the display section 12, which allows the operator to perform the teaching task while watching only the screen of the display section 12.

In the second embodiment, the camera 40 is attached to the sampling needle transfer mechanism 19. Alternatively, the camera may be fixed within the auto-sampler 10 to take an image. The image may be displayed on a display section provided separately from the display section 12 in the main body of the auto-sampler 10.

### Third Embodiment

The auto-sampler of the third embodiment is described with reference to FIG. 4. Many components in the auto-sampler 10 are similar to those described in the first embodiment. Accordingly, only the differences from the first embodiment will be described.

In the third embodiment, a camera 40, reflecting surface 42 and display section 12 are used as the appearance information acquisition assistant. As in the second embodiment, the camera 40 is equipped with a wide angle lens 41 and attached to the sampling needle transfer mechanism 19. The reflecting surface 42 is provided at an attachment position for the sample rack 17 (sample-holding-container setting section), along one side of the sample rack 17 extending in the front-rear direction.

In the third embodiment, the image taken with the camera 40 includes both an image in which the reference points 30 for position adjustment and the sampling needle 18 are directly captured and an image in which they are captured via the reflecting surface 42. That is to say, an image which shows the reference points 30 for position adjustment and the sampling needle 18 as viewed from two different directions is displayed on the display section 12. Accordingly, the operator can perform the teaching task while checking only the image displayed on the display section 12.

In the third embodiment, the camera 40 is attached to the sampling needle transfer mechanism 19, and the reflecting surface 42 is provided in the vicinity of the attachment position of the sample rack 17. Alternatively, the camera 40 may be fixed within the auto-sampler 10 to take an image, or the reflecting surface 42 may be attached to the sampling needle transfer mechanism 19. The image may be displayed on a display section provided separately from the display section 12 in the main body of the auto-sampler 10.

### Fourth Embodiment

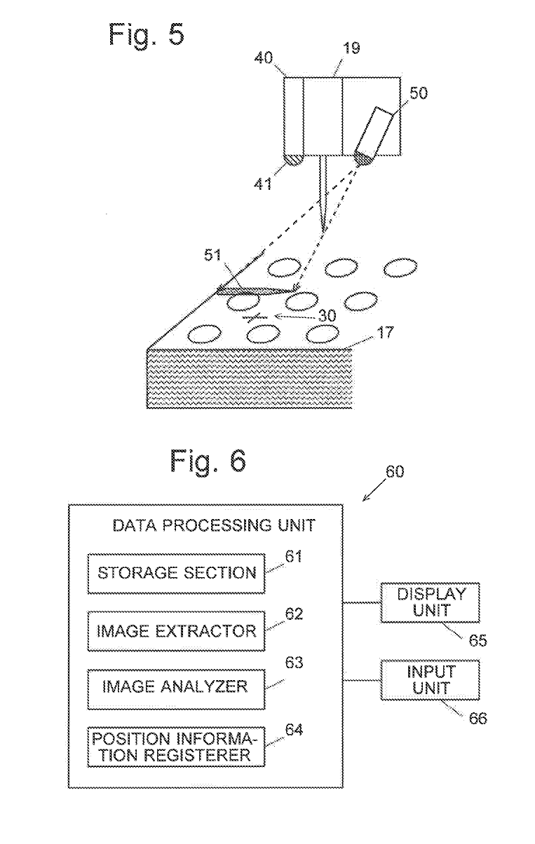

The auto-sampler of the fourth embodiment is described with reference to FIG. 5. Many components in the auto-sampler 10 are similar to those described in the first embodiment. Accordingly, only the differences from the first embodiment will be described.

In the fourth embodiment, a camera 40, LED light source 50 and display section 12 are used as the appearance information acquisition assistant. As in the second and third embodiments, the camera 40 is equipped with a wide angle lens 41 and attached to the sampling needle transfer mechanism 19. The LED light source 50 is also attached to the sampling needle transfer mechanism 19 at an angle where the light from the light source 50 illuminates the tip of the sampling needle.

In the fourth embodiment, the image taken with the camera 40 includes an image in which the reference points 30 for position adjustment and the sampling needle 18 are directly captured as well as a shadow of the sampling needle 18 cast on the top surface of the sample rack 17. The former image provides two-dimensional information concerning the positional relationship between the reference points 30 for position adjustment and the sampling needle 18, while the positional relationship of the tip of the sampling needle 18 and the shadow 51 of the sampling needle 18 provides another piece of two-dimensional information in a direction different from the former two-dimensional information. Accordingly, the operator can perform the teaching task while checking only the image displayed on the display section 12.

In the fourth embodiment, the camera 40 and LED light source 50 are attached to the sampling needle transfer mechanism 19. Alternatively, one or both of them may be fixed within the auto-sampler 10 to take an image. A light source different from the LED light source 50 may be used as the illuminator. The image may be displayed on a display section provided separately from the display section 12 in the main body of the auto-sampler 10.

All of the previous embodiments are mere examples and can be appropriately changed in accordance with the gist of the present invention. Although the first through fourth embodiments are auto-samplers used for introducing a liquid sample into a liquid chromatograph, similar configurations can also be applied in a device for collecting a solid sample and introducing it into a different type of analyzer. Although the sample rack 17 in the first through fourth embodiments has two reference points for position adjustment located on the front side of the top surface and one reference point on its rear side, the number and location of the reference points for position adjustment can be appropriately changed. It is also possible to use, as the reference points for position adjustment, some of the holes provided for holding vials.

The auto-sampler 10 which takes an image using the camera 40 as in the second through fourth embodiments may additionally be provided with a data processing unit 60 as shown in FIG. 6. The data processing unit 60 includes, in addition to a storage section 61, an image extractor 62, image analyzer 63 and position information registerer 64 as its functional blocks, as well as a display unit 65 and input unit 66 connected to it. The data processing unit 60 is actually a general-purpose computer, on which the aforementioned functional blocks operate when a preinstalled necessary program is executed. In the storage section 61, various items of information concerning the components inside the auto-sampler 10 are previously stored, which particularly include: information concerning the attachment positions of the camera 40 and LED light source 50, as well as their angles and distances to the tip of the sampling needle 18; and information concerning the position of the reflecting surface 42 (these items of information are hereinafter called the “appearance acquisition assistant arrangement information”). When the operator changes the position of the sampling needle 18 through the input unit 13 of the auto-sampler 10, the coordinate information concerning the moving distance of the needle is sequentially stored. Additionally, a piece of image data of the sampling needle 18 and that of the reference points 30 for position adjustment (these pieces of data are hereinafter called the “data for image extraction”) are stored in the storage section 61.

When an image is taken with the camera 40, the image extractor 62 reads the data for image extraction from the storage section 61 and extracts, from the taken image, the sampling needle 18 and the reference points 30 for position adjustment. Subsequently, based on the appearance acquisition assistant arrangement information, the image analyzer 63 analyzes the extracted image to determine the positional relationship of the sampling needle 18 and each reference point 30 for position adjustment, and stores that relationship in the storage section 61. After the positional relationships of the sampling needle 18 and all of the reference points 30 for position adjustment have been determined by the image analyzer 63, the position information registerer 64 registers, in the auto-sampler 10, a set of information which determines the position of each vial placement portion of the sample rack 17 based on those positional relationships. In the present mode, the teaching task can be completed without requiring the operator to check the image and sequentially adjust the position of the sampling needle 18 to each of the reference points 30 for position adjustment.

### REFERENCE SIGNS LIST

10 . . . Auto-Sampler

11 . . . Handle

12 . . . Display Section

13 . . . Input Section

16 . . . Vial

17 . . . Sample Rack

18 . . . Sampling Needle

19 . . . Sampling Needle Transfer Mechanism

20 . . . Guide Rail

22 . . . Injection Port

23, 24 . . . Passage Valve

25, 42 . . . Reflecting Surface

30 . . . Reference Point for Position Adjustment

40 . . . Camera
41 . . . Wide Angle Lens

50 . . . LED Light Source

60 . . . Data Processing Unit
61 . . . Storage Section
62 . . . Image Extractor
63 . . . Image Analyzer
64 . . . Position Information Registerer
65 . . . Display Unit
66 . . . Input Unit

1.-9. (canceled)

10. An automatic sampling device for automatically collecting a sample from a sample-holding container having a top surface on which a plurality of sample-holding portions as well as one or more reference points for position adjustment whose relative position to the sample-holding portions is previously known are provided, the automatic sampling device comprising:
a) a housing having an opening on a front side for allowing the sample-holding container to be set inside, the housing configured so that a closed space is formed inside when the opening is closed;
b) a sample collector for collecting a sample from any one of the sample-holding portions of the sample-holding container set within the housing; and
c) an appearance information acquisition assistant which assists in an acquisition of appearance information including the sample collector and the one or more reference points for position adjustment of the sample-holding container set within the housing.

11. The automatic sampling device according to claim 10, wherein the appearance information acquisition assistant is a reflector provided on a portion of an inner wall surface of the housing.

12. The automatic sampling device according to claim 10, wherein the appearance information acquisition assistant is an illuminator for illuminating the sample collector with light.

13. The automatic sampling device according to claim 10, wherein the appearance information acquisition assistant includes:
an imager for capturing the sample collector and a portion or entirety of the reference points for position adjustment within a visual field; and
a display section for displaying an image taken with the imager.

14. The automatic sampling device according to claim 10, wherein the appearance information acquisition assistant includes:
an imager for capturing the sample collector and a portion or entirety of the one or more reference points for position adjustment within a visual field;
a reflector located within the visual field of the imager and positioned in such a manner that a portion or the entirety of the one or more reference points for position adjustment are captured within the visual field of the imager via the reflector; and
a display section for displaying an image taken with the imager.

15. The automatic sampling device according to claim 10, wherein the appearance information acquisition assistant includes:
an illuminator for illuminating the sample collector with light from a lateral space within the housing;
an imager for capturing, within a visual field, the sample collector, a shadow formed by the sample collector illuminated with the light from the illuminator, and a portion or entirety of the one or more reference points for position adjustment within a visual field; and
a display section for displaying an image taken with the imager.

16. The automatic sampling device according to claim 13, comprising:
a data processor for analyzing the image taken with the imager to obtain information concerning a positional relationship between the sample collector and the one or more reference points for position adjustment.

17. The automatic sampling device according to claim 14, comprising:
a data processor for analyzing the image taken with the imager to obtain information concerning a positional relationship between the sample collector and the one or more reference points for position adjustment.

18. The automatic sampling device according to claim 15, comprising:
a data processor for analyzing the image taken with the imager to obtain information concerning a positional relationship between the sample collector and the one or more reference points for position adjustment.
